(19) United States
(12) Patent Application Publication
(10) Pub. No.: US 2009/0039783 A1
(43) Pub. Date: Feb. 12, 2009

(54) DISPLAY PANEL

(76) Inventors: Tae-Seung Cho, Suwon-si (KR); Won-Ju Yi, Suwon-si (KR); Kyoung-Doo Kang, Suwon-si (KR); Young-Do Choi, Suwon-si (KR); Jae-Ik Kwon, Suwon-si (KR); Seok-Gyun Woo, Suwon-si (KR); Yong-Shik Hwang, Suwon-si (KR); Byoung-Min Chun, Suwon-si (KR); Jong-Woo Choi, Suwon-si (KR)

Correspondence Address: CHRISTIE, PARKER & HALE, LLP, PO BOX 7068, PASADENA, CA, 91109-7068, US

(21) Appl. No.: 12/187,244

(22) Filed: Aug. 6, 2008

(30) Foreign Application Priority Data
Aug. 7, 2007 (KR) 10-2007-0079165

(51) Int. Cl. H01J 17/49

(52) U.S. Cl. 313/585

(57) ABSTRACT

A display panel including a first substrate; a second substrate separated from the first substrate; a barrier rib structure disposed between the first and second substrates defining a plurality of discharge cells; a plurality of first electrodes extending in a first direction, the first electrodes in the barrier rib structure; a plurality of second electrodes separated from the first electrodes in a second direction from the first substrate towards the second substrate, the second electrodes in the barrier rib structure; a plurality of third electrodes extending in a third direction crossing the first direction, the third electrodes on a surface of the first substrate facing the discharge cells; and a plurality of phosphor layers on surfaces of the third electrodes facing the discharge cells.

### CROSS-REFERENCE TO RELATED PATENT APPLICATION

This application claims priority to and the benefit of Korean Patent Application No. 10-2007-0079165, filed on Aug. 7, 2007, in the Korean Intellectual Property Office, the disclosure of which is incorporated herein in its entirety by reference.

### BACKGROUND

1. Field

The present invention relates to a display panel, and more particularly, to a display panel having a structure in which plasma electrons, which are generated by a plasma discharge that occurs between first and second electrodes at an end of a discharge cell, are utilized to generate light emission from a phosphor layer.

2. Description of the Related Art

Plasma display panels have recently drawn attention as a replacement for conventional cathode ray tube display devices. Plasma display panels are apparatuses that display images using visible light emitted from phosphor materials, which are formed in a predetermined pattern, excited by ultraviolet rays generated from a discharge of a discharge gas filled between two substrates, on which a plurality of electrodes are formed, when a discharge voltage is applied to the electrodes.

FIG. 1 is a partial exploded perspective view of a conventional plasma display panel 100. Referring to FIG. 1, the conventional plasma display panel 100 includes a front substrate 101, sustain electrodes 106 and 107 disposed on the front substrate 101, a front dielectric layer 109 covering the sustain electrodes 106 and 107, a protective layer 111 covering the front dielectric layer 109, a rear substrate 115 facing the front substrate 101, a plurality of address electrodes 117 disposed parallel to each other on the rear substrate 115, a rear dielectric layer 113 covering the address electrodes 117, a plurality of barrier ribs 114 formed on the rear dielectric layer 113, and phosphor layers 110 formed on upper surfaces of the rear dielectric layer 113 and on side surfaces of the barrier ribs 114.

However, the conventional plasma display panel 100 conventionally has a structural limit in terms of increasing light emission efficiency. Accordingly, there is a desire to develop a display panel having a new structure other than that of the conventional plasma display panel.

### SUMMARY

Exemplary embodiments of the present invention include a display panel that can increase discharge efficiency by employing a new structure in which plasma electrons, which are generated by a plasma discharge between first and second electrodes at an end of a discharge cell, are attracted toward an anode disposed on the other end of the discharge cell to emit light by colliding with a phosphor layer disposed on the anode.

According to a first exemplary embodiment of the present invention, a display panel includes a first substrate; a second substrate separated from the first substrate; a barrier rib structure disposed between the first and second substrates defining a plurality of discharge cells; a plurality of first electrodes extending in a first direction, the first electrodes in the barrier rib structure; a plurality of second electrodes separated from the first electrodes in a second direction from the first substrate towards the second substrate, the second electrodes in the barrier rib structure; a plurality of third electrodes extending in a third direction crossing the first direction, the third electrodes on a surface of the first substrate facing the discharge cells; and a plurality of phosphor layers on surfaces of the third electrodes facing the discharge cells.

Plasma discharge may be generated between the first and second electrodes by a positive voltage applied to the first electrodes and a negative voltage applied to the second electrodes.

A first positive voltage having a level higher than the positive voltage applied to the first electrodes may be applied to the third electrodes.

The first and second electrodes may be in a first barrier rib layer of the barrier rib structure, and a second barrier rib layer of the barrier rib structure may be between the first barrier rib layer and the first substrate.

A first portion of the discharge cells in the first barrier rib layer may have a cross-sectional area smaller than a second portion of the discharge cells in the second barrier rib layer.

The barrier rib structure may comprise a dielectric material.

At least portions of the first and second electrodes may be buried in the barrier rib structure so that at least portions of the first and second electrodes may be exposed through the discharge cells.

The first and second electrodes may extend in the same direction, or substantially parallel to each other.

The first and second electrodes may be disposed to substantially surround the discharge cells.

The discharge cells may have a horizontal cross-section having a circular or an oval shape, or a rectangular shape.

Each of the third electrodes may include a transparent electrode through which visible light generated in the discharge cells passes and a bus electrode having a width narrower and a higher electrical conductivity than the transparent electrode.

At least two adjacent discharge cells may comprise a sub-pixel for emitting monochromatic light.

According to a second exemplary embodiment of the present invention, a display panel includes a plurality of discharge cells defined by a barrier rib structure between first and second substrates that are separated and facing each other, wherein plasma electrons, which are generated on a side of the discharge cells that is close to the second substrate, are attracted toward a side of the discharge cells close to the first substrate and collide with phosphor layers on a lower surface of the first substrate to generate visible light, and the visible light is emitted to the outside through the first substrate in order to display an image.

In a display panel according to various exemplary embodiments of the present invention, plasma electrons generated due to a plasma discharge between first and second electrodes at an end of discharge cells are attracted toward an anode disposed on the other end of the discharge cells. The plasma electrons are allowed to collide with phosphor layers formed on the anode to generate visible light. Therefore, the display panel according to the present invention can increase discharge efficiency.

### BRIEF DESCRIPTION OF THE DRAWINGS

The above and other features and aspects of the present invention will become more apparent by describing in detail exemplary embodiments thereof with reference to the attached drawings in which:

FIG. 1 is a partial exploded perspective view of a conventional plasma display panel;

FIG. 2 is a partial exploded perspective view illustrating a display panel, with a new structure, according to an exemplary embodiment of the present invention;

FIG. 3 is a cross-sectional view taken along the line III-III of the display panel of FIG. 2; and

FIG. 4 is a schematic perspective view illustrating the structure of first and second electrodes in the display panel of FIG. 2.

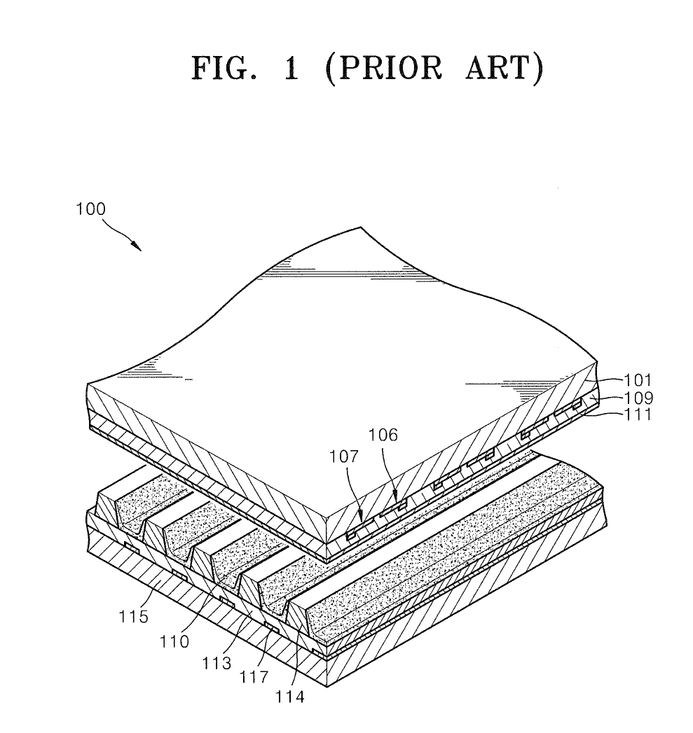

### DETAILED DESCRIPTION OF EXEMPLARY EMBODIMENTS

The present invention will now be described more fully with reference to the accompanying drawings in which exemplary embodiments of the invention are shown. In the drawings, the thicknesses of layers and regions are exaggerated for clarity, and like reference numerals refer to like elements throughout.

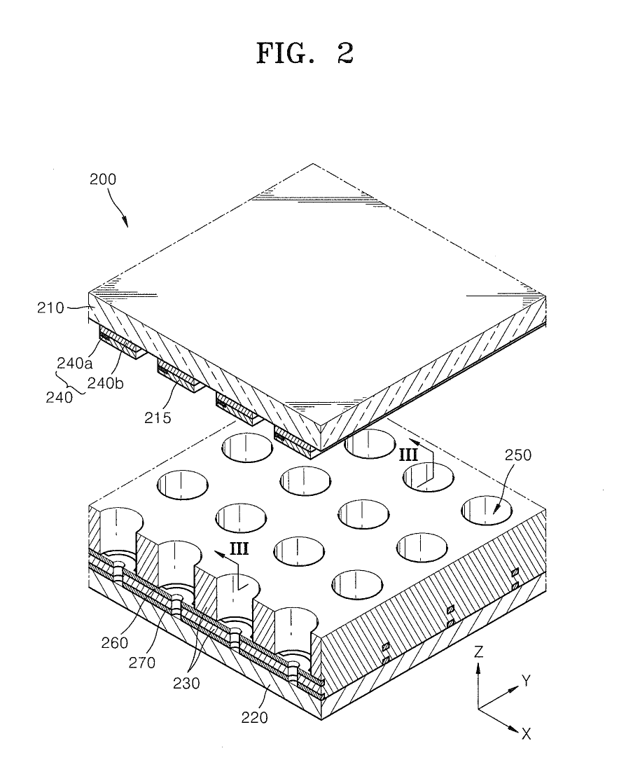

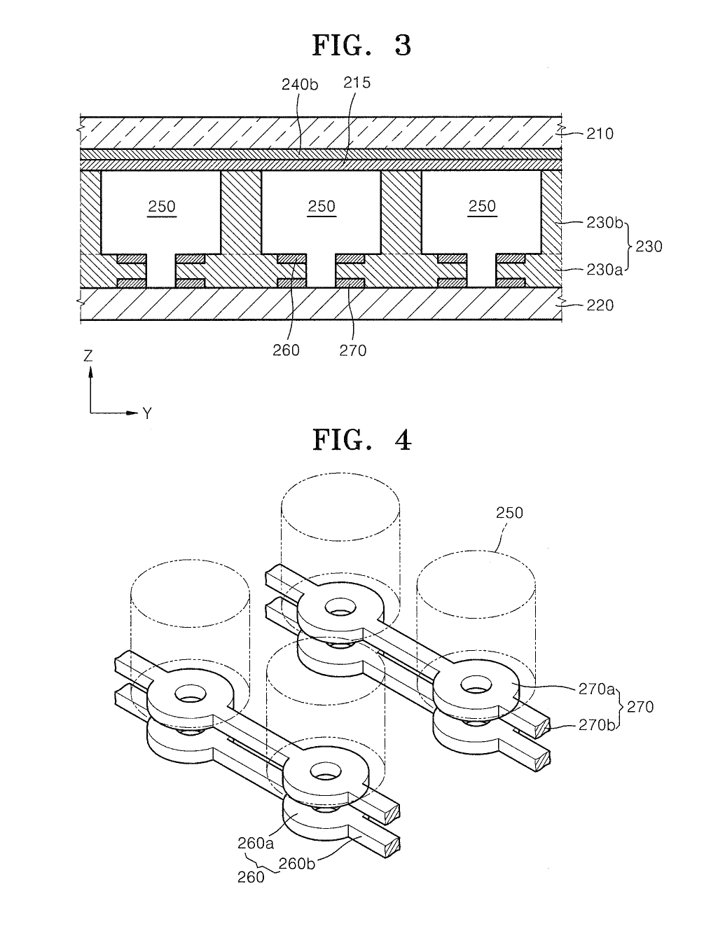

FIG. 2 is a partial exploded perspective view illustrating a display panel 200, with a new structure, according to an exemplary embodiment of the present invention. FIG. 3 is a cross-sectional view taken along the line III-III of the display panel 200 of FIG. 2, and FIG. 4 is a schematic perspective view illustrating the structure of first and second electrodes 260 and 270 in the display panel 200 of FIG. 2, according to exemplary embodiments of the present invention.

The display panel 200 with a new structure includes a first substrate 210, a second substrate 220, a barrier rib structure 230, first electrodes 260, second electrodes 270, third electrodes 240, and phosphor layers 215.

In the display panel 200, a plurality of discharge cells 250 are defined by the barrier rib structure 230 disposed between the first and second substrates 210 and 220, which face each other and are separated from each other. In the display panel 200, visible light is generated when plasma electrons generated at the second substrate 220 of the discharge cells 250 collide with the phosphor layers 215 disposed on the first substrate 210 by being attracted toward the first substrate 210. Thus, according to this embodiment, the display panel 200 displays an image by emitting the visible light to the outside through the first substrate 210.

The first substrate 210 and the second substrate 220 are separated from each other and disposed so that a large surface area of each of the first and second substrates 210 and 220 face each other. The barrier rib structure 230 is disposed between the first substrate 210 and the second substrate 220, and defines the discharge cells 250.

The first electrodes 260 extend in a direction in the barrier rib structure 230 between the first substrate 210 and the second substrate 220. The second electrodes 270 are formed in the barrier rib structure 230 by being separated from the first electrodes 260 in a direction from the first substrate 210 towards the second substrate 220. The third electrodes 240 extend in a direction crossing the first electrodes 260 and the second electrodes 270 on a surface of the first substrate 210 facing the discharge cells 250.

The phosphor layers 215 are respectively formed on the surfaces of the third electrodes 240.

At least one of the first and second substrates 210 and 220 is usually formed of a high optical transmittance material, for example, glass as a main component. However, in order to increase contrast by reducing the reflection brightness, at least one of the first and second substrates 210 and 220 may be colored in some embodiments.

In the present embodiment, visible light generated in the discharge cells 250 can be emitted to the outside through the first substrate 210. However, the present invention is not limited thereto; that is, the visible light generated in the discharge cells 250 can be emitted to the outside through the second substrate 220 according to embodiments of the present invention.

Referring to FIGS. 2 and 3, the barrier rib structure 230 that defines the discharge cells 250 and prevents electrical and optical cross-talk between the discharge cells 250 is disposed between the first and second substrates 210 and 220. In the present embodiment, the barrier rib structure 230 defines the discharge cells 250 with circular cross-sections; however, the present invention is not limited thereto.

Hence, the barrier rib structure 230 can have any other pattern as long as the barrier rib structure 230 defines a plurality of discharge cells 250. For example, the horizontal cross-sections of the discharge cells 250 can be a polygonal shape, such as a triangular, rectangular, or pentagonal shape; circular shape; or oval shape. Also, the barrier rib structure 230 can be formed to define the discharge cells 250 with a delta or a waffle shape.

Also, the barrier rib structure 230 may be formed of a dielectric material. Portions of the first and second electrodes 260 and 270 are buried in the barrier rib structure 230, and other portions of the first and second electrodes 260 and 270 can be exposed through the discharge cells 250. The barrier rib structure 230 may be formed of a dielectric material that can prevent a direct electrical connection between the adjacent first and second electrodes 260 and 270 and can induce charges.

The barrier rib structure 230 includes a first barrier rib portion 230a and a second barrier rib portion 230b. Each pair of first and second electrodes 260 and 270 is disposed in the first barrier rib portion 230a of the barrier rib structure 230. The second barrier rib portion 230b is disposed between the first barrier rib portion 230a and the first substrate 210.

The pairs of first and second electrodes 260 and 270 generate discharge in the discharge cells 250. Each of the first electrodes 260 extends in a first direction (for example, an X direction) and surrounds the discharge cells 250, and includes a first loop 260a that surrounds each discharge cell 250 and a first loop connection unit 260b that connects the first loops 260a.

In the present embodiment, the first loop 260a has a circular loop shape. However, the shape of the first loop 260a according to the present invention is not limited thereto, and can have various other shapes. However, the first loop 260a may have a shape substantially identical to the shape of the horizontal cross-section of the discharge cells 250.

Each of the second electrodes 270 extends in the first direction (the X direction) in the same direction as the first electrodes 260 and surrounds the discharge cells 250. Thus, the second electrodes 270 are separated from the first electrodes 260 in the barrier rib structure 230 in a direction (a Z direction) from the first substrate 210 towards the second substrate 220. The second electrodes 270 may be disposed closer to the second substrate 220 than the first electrodes 260.

Each of the second electrodes 270 includes a second loop 270a that surrounds each of the discharge cells 250 and a second loop connection unit 270b that connects the second loops 270a. In the present embodiment, the second loop 270a has a ring shape. However, the shape of the second loop 270a according to the present invention is not limited thereto, and can have various other shapes, for example, a rectangular loop shape. The second loop 270a may have a shape substantially identical to the shape of the horizontal cross-section of the discharge cells 250.

The first and second electrodes 260 and 270 may extend in the same direction parallel to each other.

Portions of the first and second electrodes 260 and 270 may be buried in the barrier rib structure 230, and other portions of the first and second electrodes 260 and 270 can be exposed through the discharge cells 250. In this way, since portions of the first and second electrodes 260 and 270 are exposed through the discharge cells 250, it is unnecessary to form a protective layer (not shown) for protecting the barrier rib structure 230 formed of a dielectric and the first and second electrodes 260 and 270 from being damaged by sputtering plasma particles.

The display panel 200 according to the present embodiment can be an alternating current (AC) type display panel. However, in this case, the efficiency of the display panel can be relatively reduced since a voltage must be alternately applied to the first and second electrodes 260 and 270 to use wall charges. Therefore, the display panel 200 according to the present embodiment may be a direct current (DC) type display panel in which portions of the first and second electrodes 260 and 270 may exposed in discharge spaces of the discharge cells 250.

Also, since the first and second electrodes 260 and 270 are not disposed in locations that can directly reduce the transmittance of visible light, the first and second electrodes 260 and 270 can be formed of a conductive metal such as aluminium or copper. Accordingly, a voltage drop in a lengthwise direction of the first and second electrodes 260 and 270 is small, thereby enabling stable signal transmission.

The third electrodes 240 extend in a direction crossing the first and second electrodes 260 and 270 on the surface of the first substrate 210 facing the discharge cells 250. Each of the third electrodes 240 includes a transparent electrode 240b through which visible light generated in the discharge cells 250 can pass and a bus electrode 240a having a width narrower and a higher electrical conductivity than the transparent electrode 240b.

The transparent electrode 240b is formed of a transparent conductive material such as indium tin oxide (ITO) that can generate discharge and does not substantially interrupt the propagation of visible light generated from the phosphor layers 215 to the front substrate 210. However, the transparent conductive material such as ITO generally has a high resistance. Accordingly, if the third electrodes 240 are formed only as transparent conductive electrodes, a voltage drop in the lengthwise direction of the first and second electrodes 260 and 270 is large, and thereby, increasing power consumption and causing a long response time of the display panel 200. To address these issues, the bus electrode 240a, which is formed of a metal (i.e., a material having a higher conductivity than the transparent electrode) having a narrower width than the transparent electrode 240b, is formed on the transparent electrode 240b.

The bus electrodes 240a are disposed parallel to each other, spaced apart from each other (e.g., at a predetermined distance) corresponding to unit discharge cells 250, and extend across the discharge cell 250. As described above, the transparent electrodes 240b are electrically connected to the bus electrodes 240a, and in this case, each of the transparent electrodes 240b has a rectangular shape and can be discretely formed into portions such that the portions correspond to the discharge cells 250. One portion of the transparent electrodes 240b can be in contact with the bus electrodes 240a, and another portion of the transparent electrodes 240b can be disposed to face the discharge cells 250.

The phosphor layers 215 are formed on surfaces of the third electrodes 240 facing the discharge cells 250. The location of the phosphor layers 215 is not limited thereto, and can be formed in various other locations. For example, the phosphor layers 215 can be disposed on side walls of the barrier rib structure 230 in other embodiments.

Plasma electrons generated due to the discharge between the first and second electrodes 260 and 270 are attracted by a strong electric field formed by the third electrodes 240, and collide with the phosphor layers 215 formed on surfaces of the third electrodes 240. Thus, visible light is emitted from the phosphor layers 215. At this point, the phosphor layers 215 can be red, green, and blue color phosphor layers, which are respectively formed by coating phosphor materials that generate red, green, and blue light by colliding with electrons.

Also, to have effective discharge between the first and second electrodes 260 and 270, a discharge gas such as Ne gas, Xe gas, or a mixture of Ne gas and Xe gas can be filled in the discharge cells 250.

The plasma discharge is generated between the first and second electrodes 260 and 270, for example, when a positive voltage is applied to the first electrodes 260 and a negative voltage is applied to the second electrodes 270. Also, a positive voltage having a level higher than the voltage applied to the first electrodes 260 is applied to the third electrodes 240.

At this point, in the discharge spaces formed in the discharge cells 250 between the first barrier rib portion 230a, effective and strong discharge is initiated by the discharge between the ring shaped first and second electrodes 260 and 270. As a result, a strong plasma column is formed in a central portion of the ring, and electron density in this portion rapidly increases. That is, the plasma generated due to the discharge between the first and second electrodes 260 and 270 is a large electron source.

The plasma electrons generated in this manner are attracted towards the third electrodes 240 where an electric field is formed due to the strong positive voltage. Accordingly, the plasma formed in the discharge spaces in the narrow first barrier rib portion 230a is distributed into the relatively large discharge spaces between the second barrier rib portion 230b.

At this point, the migration speed of the plasma electrons is accelerated by applying a high voltage of 1 kV or higher to the third electrodes 240. Thus, the accelerated plasma electrons directly collide with the phosphor layers 215 and excite the phosphor materials of the phosphor layers 215 to emit visible light for displaying an image. The third electrodes 240 can function as address electrodes that select discharge cells 250 to be displayed from all the discharge cells 250 by applying a voltage to the third electrodes 240.

Also, the rings formed by the first and second electrodes 260 and 270 that substantially generate effective plasma columns generally have a diameter much smaller than a pixel. Therefore, multiple discharge cells 250 adjacent to each other may be formed as a sub-pixel that emits monochromatic light. For example, another embodiment includes two adjacent discharge cells 250 that form a sub-pixel that emits monochromatic light, and six discharge cells 250 can form one pixel.

In a display panel according to various embodiments of the present invention, plasma electrons generated due to discharge between first and second electrodes at an end of each of the discharge cells are attracted toward an anode disposed on the other ends of the discharge cells. The plasma electrons are allowed to collide with phosphor layers formed on the anode to generate visible light. Therefore, the display panel according to embodiments of the present invention can increase the discharge efficiency of the display panel.

While the present invention has been particularly shown and described with reference to exemplary embodiments thereof, it will be understood by one of ordinary skill in the art that various changes in form and details may be made therein without departing from the spirit of the present invention, the scope of which is defined by the following claims and their equivalents.

What is claimed is:

1. A display panel comprising:
a first substrate;
a second substrate spaced apart from the first substrate;
a barrier rib structure between the first and second substrates and defining a plurality of discharge cells;
a plurality of first electrodes extending in a first direction, the first electrodes in the barrier rib structure;
a plurality of second electrodes separated from the first electrodes in a second direction from the first substrate towards the second substrate, the second electrodes in the barrier rib structure;
a plurality of third electrodes extending in a third direction crossing the first direction, the third electrodes on a side of the first substrate facing the discharge cells; and
a plurality of phosphor layers on surfaces of the third electrodes facing the discharge cells.

2. The display panel of claim 1, wherein a plasma discharge is generated between the first and second electrodes by a positive voltage applied to the first electrodes and a negative voltage applied to the second electrodes.

3. The display panel of claim 2, wherein another positive voltage having a level higher than the positive voltage applied to the first electrodes is applied to the third electrodes.

4. The display panel of claim 1, wherein:
the barrier rib structure comprises a first barrier rib layer and a second barrier rib layer;
the first and second electrodes are in the first barrier rib layer of the barrier rib structure; and
the second barrier rib layer of the barrier rib structure is between the first barrier rib layer and the first substrate.

5. The display panel of claim 4, wherein a first portion of the discharge cells in the first barrier rib layer has a cross-sectional area smaller than a second portion of the discharge cells in the second barrier rib layer.

6. The display panel of claim 1, wherein the barrier rib structure comprises a dielectric material.

7. The display panel of claim 1, wherein at least portions of the first and second electrodes are exposed through the discharge cells.

8. The display panel of claim 7, wherein at least portions of the first and second electrodes are buried in the barrier rib structure.

9. The display panel of claim 1, wherein the first and second electrodes extend substantially parallel to each other.

10. The display panel of claim 1, wherein the first and second electrodes extend in substantially the same direction.

11. The display panel of claim 1, wherein the first and second electrodes surround the discharge cells.

12. The display panel of claim 1, wherein the discharge cells have a horizontal cross-section having a circular or oval shape, or a rectangular shape.

13. The display panel of claim 1, wherein each of the third electrodes comprises a transparent electrode through which visible light generated in the discharge cells passes and a bus electrode having a width narrower than the transparent electrode and a higher electrical conductivity than the transparent electrode.

14. The display panel of claim 1, wherein the third electrodes are utilized to select the discharge cells to be displayed by applying a voltage to the third electrodes of a selected discharge cell of the plurality of discharge cells.

15. The display panel of claim 1, wherein at least two adjacent discharge cells comprise a sub-pixel for emitting monochromatic light.

16. A display panel comprising a plurality of discharge cells defined by a barrier rib structure between first and second substrates that are spaced apart from and facing each other, wherein plasma electrons, which are generated at a side of the discharge cells that is close to the second substrate, are attracted toward a side of the discharge cells close to the first substrate and collide with phosphor layers on a surface of the first substrate to generate visible light, and the visible light is emitted outside of the display panel through the first substrate to display an image.

17. The display panel of claim 16, wherein the barrier rib structure comprises a first barrier rib layer for generating plasma electrons and a second barrier rib layer between the first barrier rib layer and the first substrate.

18. The display panel of claim 17, further comprising first electrodes extending in a first direction in the first barrier rib layer, and second electrodes separated from the first electrodes in the first barrier rib layer in a second direction from the first substrate towards the second substrate.

19. The display panel of claim 18, further comprising third electrodes extending in a third direction crossing the first direction on a surface of the first substrate facing the discharge cells, and the phosphor layers are on a surface of the third electrodes which are on the surface of the first substrate.

20. The display panel of claim 18, wherein a plasma discharge is generated between the first and second electrodes by applying a positive voltage to the first electrodes and a negative voltage to the second electrodes, and another positive voltage having a level higher than the positive voltage applied to the first electrodes is applied to the third electrodes.

21. The display panel of claim 17, wherein a first portion of the discharge cells in the first barrier rib layer has a cross-sectional area smaller than a second portion of the discharge cells in the second barrier rib layer.

22. The display panel of claim 18, wherein at least a portion of the first and second electrodes is exposed through the discharge cells.

23. The display panel of claim 16, wherein the barrier rib structure comprises a dielectric material.

24. The display panel of claim 18, wherein the first and second electrodes extend in substantially the same direction parallel to each other.

25. The display panel of claim 18, wherein a horizontal cross-section of the discharge cells has a circular or oval shape, or a rectangular shape, and portions of the first and second electrodes surround the discharge cells.

26. The display panel of claim 19, wherein each of the third electrodes comprises a transparent electrode through which visible light generated in the discharge cells passes and a bus electrode having a width narrower than the transparent electrode and a higher electrical conductivity than the transparent electrode.

27. The display panel of claim 16, wherein at least two adjacent discharge cells form a sub-pixel for emitting monochromatic light.
